(19) United States
(12) Patent Application Publication
(10) Pub. No.: US 2018/0275612 A1
(43) Pub. Date: Sep. 27, 2018

(54) ELECTRONIC TIMEPIECE

(71) Applicant: SEIKO EPSON CORPORATION, Tokyo (JP)

(72) Inventor: Toshiyuki NOZAWA, Okaya-shi (JP)

(73) Assignee: SEIKO EPSON CORPORATION, Tokyo (JP)

(21) Appl. No.: 15/916,647

(22) Filed: Mar. 9, 2018

(30) Foreign Application Priority Data
Mar. 23, 2017 (JP) 2017-058231

(51) Int. Cl. G04B 47/06; G04C 3/14; G04G 21/02; G01C 17/28; G01C 17/38

(52) U.S. Cl. CPC G04B 47/065; G04C 3/14; G01C 17/38; G01C 17/28; G04G 21/02

(57) ABSTRACT

An electronic timepiece includes a mode setter that sets an azimuth mode in which the azimuth is measured and displayed, at least one indicating hand that operates when the azimuth mode is set, markings at which the indicating hand points, a stepper motor including a rotor, a wheel train that moves the indicating hand in synchronization with the rotor, a magnetism sensor, and an azimuth measurer that measures magnetism with the magnetism sensor when the azimuth mode is set and acquires the azimuth based on the measured magnetism information. The reduction ratio of the wheel train is so set that the indicating hand moves by the distance corresponding to one marking when the rotor makes N turns, where N is an integer greater than or equal to 1, and the azimuth measurer measures the magnetism during the period for which the indicating hand stationarily points at any of the markings.

### CROSS-REFERENCE TO RELATED APPLICATION

This nonprovisional application claims the benefit of Japanese Patent Application No. 2017-058231 filed Mar. 23, 2017, the enter disclosure which is incorporated herein by reference.

### BACKGROUND

### 1. Technical Field

The present invention relates to an electronic timepiece having an azimuth measuring function.

### 2. Related Art

There has been a known analog electronic timepiece having a compass function of measuring the azimuth (see U.S. Pat. No. 6,992,481, for example).

The analog electronic timepiece described in U.S. Pat. No. 6,992,481 measures magnetism with a sensor and acquires the azimuth based on the measured magnetism. The electronic timepiece further includes a stepper motor that drives the second hand. The stepper motor includes a two-pole rotor formed of a permanent magnet and causes the rotor to pivot one step of 180° every one second. According to the configuration described above, when the magnetism is measured, the following cases occur: a case where the rotor is oriented in a first direction; and a case where the rotor is oriented in a second direction shifted from the first direction by 180°. In these cases, magnetic fields different from each other are produced.

When the magnetic field produced in the timepiece varies whenever the magnetism is measured, the azimuth cannot be measured with accuracy. To avoid the problem, the analog electronic timepiece described in U.S. Pat. No. 6,992,481 detects the orientation of the rotor before the magnetism measurement. When the orientation of the rotor is a specified orientation, the magnetism is measured with the orientation of the rotor unchanged. On the other hand, when the orientation of the rotor is not the specified orientation (when the orientation is shifted from the specified orientation by 180°), the magnetism is measured after the rotor is caused to pivot by 180° so that the orientation of the rotor is the specified orientation. As described above, whenever the magnetism is measured, the orientation of the rotor is caused to be the specified orientation, whereby the same-state magnetic field produced in the timepiece is measured.

In the analog electronic timepiece described in U.S. Pat. No. 6,992,481, the orientation of the rotor is detected before the magnetism is measured, and when the orientation of the rotor is not the specified orientation, the rotor is caused to pivot, followed by the magnetism measurement. The procedure undesirably requires a long time for azimuth measurement.

### SUMMARY

An advantage of some aspects of the invention is to provide an electronic timepiece capable of shortening the period required for azimuth measurement.

An electronic timepiece according to an aspect of the invention includes a mode setter that sets an azimuth mode in which an azimuth is measured and displayed, at least one indicating hand that operates when the azimuth mode is set, markings at which the indicating hand points, a stepper motor including a rotor, a wheel train that moves the indicating hand in synchronization with the rotor, a magnetism sensor, and an azimuth measurer that measures magnetism with the magnetism sensor when the azimuth mode is set and acquires the azimuth based on the measured magnetism information. A reduction ratio of the wheel train is so set that the indicating hand moves by a distance corresponding to one marking when the rotor makes N turns, where N is an integer greater than or equal to 1, and the azimuth measurer measures the magnetism during a period for which the indicating hand stationarily points at any of the markings.

In the aspect of the invention, the reduction ratio of the wheel train is so set that the indicating hand moves over the distance corresponding to one marking segment when the rotor makes N turns. Therefore, when the indicating hand stationarily points at any of the markings, the rotor is always oriented in the same direction. Causing the azimuth measurer to measure the magnetism during the period for which the indicating hand stationarily points at any of the markings therefore allows magnetism measurement with the magnetic field produced in the timepiece maintained in the same state whenever the magnetism is measured, whereby the azimuth can be measured with accuracy.

Further, since the rotor is not required to pivot before the magnetism measurement, the period necessary for the azimuth measurement can be shortened.

In the electronic timepiece according to the aspect of the invention, it is preferable that the mode setter sets a calibration mode in which a correction value for correcting the magnetism information is acquired, that the electronic timepiece further includes a calibrator that acquires the correction value when the calibration mode is set by measuring the magnetism with the magnetism sensor during a period for which the indicating hand stationarily points at any of the markings, and that the azimuth measurer corrects the magnetism information based on the correction value to acquire the azimuth.

The correction value is, for example, a magnetic field produced in the timepiece (offset magnetic field). The offset magnetic field can be acquired, for example, by measuring the magnetism with the orientation of the electronic timepiece changed.

According to the aspect of the invention with this configuration, when the magnetism is measured to acquire the correction value, the rotor is allowed to have the same orientation with which the azimuth measurement is performed. The magnetic field produced in the timepiece can therefore be maintained in the same state as that in the azimuth measurement, whereby an appropriate correction value can be acquired. Correcting the magnetism information measured in the azimuth measurement by using the correction value to acquire the azimuth therefore allows accurate azimuth measurement.

It is preferable that the electronic timepiece according to the aspect of the invention further includes a mode hand provided separately from the indicating hand, an azimuth mode marking at which the mode hand points when the azimuth mode is set, a calibration mode marking at which the mode hand points when the calibration mode is set, and a stepper motor for the mode hand including a rotor for the mode hand, and that the mode hand moves between the azimuth mode marking and the calibration mode marking when the rotor for the mode hand makes n turns, where n is an integer greater than or equal to 1.

In the aspect of the invention with this configuration, the mode hand moves between the azimuth mode marking and the calibration mode marking when the rotor for the mode hand makes n turns. The rotor for the mode hand is therefore allowed to have the same orientation both in the case where the mode hand points at the azimuth mode marking and the case where the mode hand points at the calibration mode marking. The magnetic field produced in the timepiece is therefore allowed to have the same state both in the azimuth measurement and the correction value acquisition. Therefore, even when the stepper motor for the mode hand is provided, an appropriate correction value can be acquired.

It is preferable that the electronic timepiece according to the aspect of the invention further includes a second hand provided separately from the indicating hand, second markings at which the second hand points, and a stepper motor for the second hand that includes a rotor for the second hand and moves the second hand over a distance corresponding to one marking when the rotor for the second hand is caused to make a half turn every one second, and that the second hand stops with the rotor for the second hand having a predetermined orientation when the azimuth mode is set.

Since the indicating hand described above moves over the distance corresponding to one marking segment when the rotor makes at least one turn, the electric power required to move the indicating hand over the distance corresponding to one marking segment is greater than, for example, in a case where the indicating hand moves over the distance corresponding to one marking segment when the rotor makes a half turn. Therefore, in a case where the indicating hand is, for example, the second hand, which moves over the distance corresponding to one marking segment every one second, the electric power consumed by the timepiece increases.

In contrast, in the aspect of the invention with the configuration described above, the second hand is provided separately from the indicating hand described above, and the second hand moves over the distance corresponding to one marking segment when the rotor for the second hand makes a half turn every one second. The electric power consumed by the timepiece can therefore be lowered as compared with the case where the indicating hand is the second hand.

Further, according to the aspect of the invention with the configuration described above, when the azimuth mode is set, the rotor for the second hand is stationary and has a predetermined orientation. The magnetism can therefore be measured with the magnetic field produced in the timepiece maintained in the same state whenever the magnetism is measured, whereby the azimuth can be measured with accuracy.

It is preferable that the electronic timepiece according to the aspect of the invention further includes a second hand provided separately from the indicating hand, second markings at which the second hand points, a stepper motor for the second hand that includes a rotor for the second hand and moves the secondhand over a distance corresponding to one marking when the rotor for the second hand is caused to make a half turn every one second, and an orientation detector that detects an orientation of the rotor for the second hand, that the second hand moves every one second when the azimuth mode is set, and that the azimuth measurer corrects the measured magnetism information in accordance with the orientation of the rotor for the second hand to acquire the azimuth.

In the aspect of the invention with this configuration, since the second hand is provided separately from the indicating hand described above, and the second hand moves over the distance corresponding to one marking segment when the rotor for the second hand makes a half turn every one second, the electric power consumed by the timepiece can be lowered as compared with the case where the indicating hand described above is the second hand.

Further, according to the aspect of the invention with the configuration described above, the second hand can display the second even during the period for which the azimuth mode is set.

Moreover, since the second hand moves even during the period for which the azimuth mode is set, the rotor of the second hand does not always have the same orientation when the magnetism is measured. Therefore, in the aspect of the invention with the configuration described above, when the magnetism is measured, the orientation of the rotor for the secondhand is detected, and the measured magnetism information is corrected in accordance with the detected orientation of the rotor for the secondhand, followed by azimuth acquisition. A decrease in the accuracy in the azimuth measurement can thus be suppressed.

### BRIEF DESCRIPTION OF THE DRAWINGS

The invention will be described with reference to the accompanying drawings, wherein like numbers reference like elements.

FIG. 1 is a front view of an electronic timepiece according to a first embodiment of the invention.

FIG. 2 is a block diagram showing the configuration of a movement in the first embodiment.

FIG. 3 shows the configuration of a motor for a center hand in the first embodiment.

FIG. 4 is a flowchart showing an azimuth measurement action in the first embodiment.

FIG. 5 is a front view if an electronic timepiece according to a second embodiment of the invention.

FIG. 6 is a block diagram showing the configuration of a movement in the second embodiment.

FIG. 7 is a block diagram showing the function of a CPU in another embodiment of the invention.

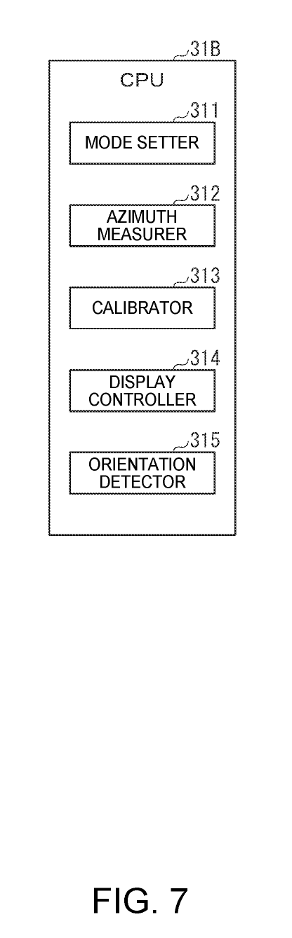

### DESCRIPTION OF EXEMPLARY EMBODIMENTS

Embodiments according to the invention will be described below with reference to the drawings.

### First Embodiment

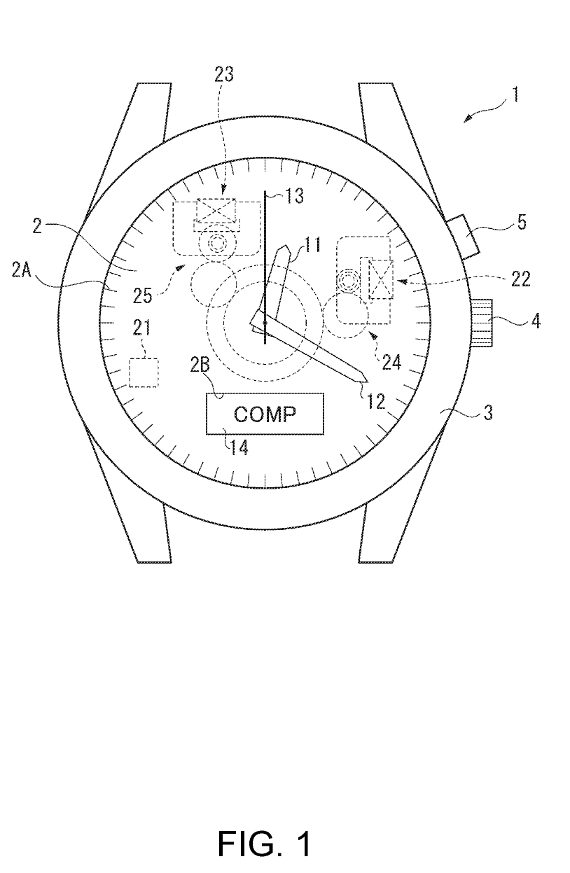

FIG. 1 is a front view showing an electronic timepiece 1.

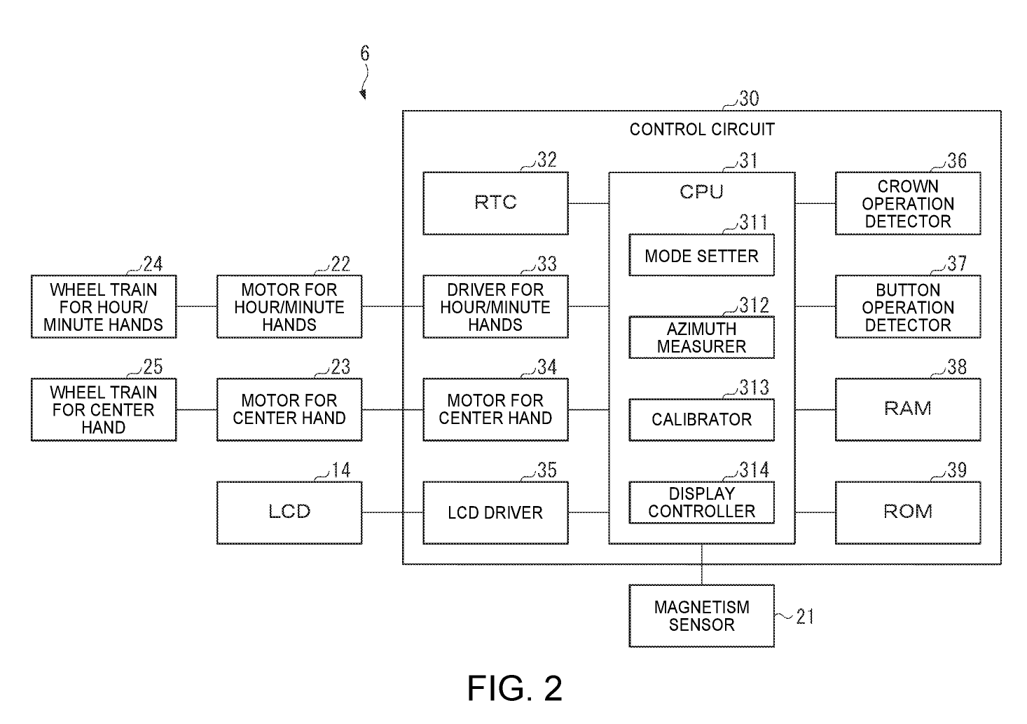

The electronic timepiece 1 includes an exterior case 3 and an hour hand 11, a minute hand 12, a center hand 13, a dial 2, and a movement 6 (see FIG. 2), which are accommodated in the exterior case 3, as shown in FIG. 1.

The dial 2 is formed in a disc-like shape, and markings 2A, which are so provided around the outer circumference of the dial 2 as to divide the circumference thereof into 60 segments. A rotating shaft is provided at the center of the dial 2 in a plan view, and the hour hand 11, the minute hand 12, and the center hand 13 (indicating hand) are attached to the rotating shaft. The center hand 13 points at any of the markings 2A to display the north cardinal point (bearing). That is, the north cardinal point is displayed in the unit of 6°. The hour hand 11 and the minute hand 12 each point at any of the markings 2A to display the hour and minute of the time.

The dial 2 is further provided with an opening 2B in a 6-o'clock position with respect to the center of the dial 2 in a plan view viewed from the side facing the front surface of the timepiece. Letters displayed by an LCD (liquid crystal display) 14, which is provided in the movement 6 provided on the rear side of the dial 2, are visually recognized through the opening 2B. The LCD 14 displays a mode in the present embodiment.

The exterior case 3 is provided with a crown 4, which is an externally operated member, and a button 5, which is another externally operated member.

### Configuration of Movement

FIG. 2 is a block diagram showing the configuration of the movement 6.

The movement 6 includes a magnetism sensor 21, a motor 22 for the hour/minute hands, a motor 23 for the center hand, a wheel train 24 for the hour/minute hands, a wheel train 25 for the center hand, the LCD 14, and a control circuit 30.

The magnetism sensor 21 is, for example, a three-axis magnetism sensor, measures magnetism to acquire magnetism information, and outputs the acquired magnetism information to the control circuit 30. The magnetism sensor 21 is disposed in an 8-o'clock position with respect to the center of the dial 2 in the plan view, as shown in FIG. 1.

The motor 23 for the center hand is formed of a two-pole stepper motor.

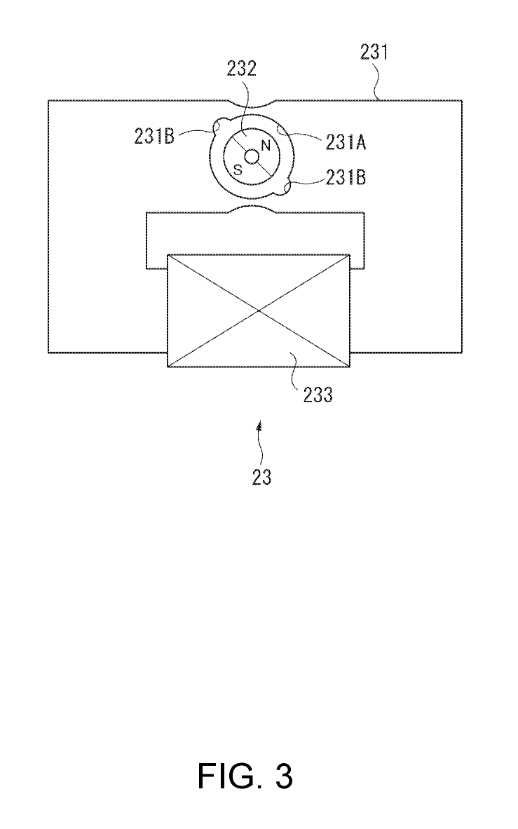

The motor 23 for the center hand includes a stator 231, which has a rotor accommodating hole 231A, a rotor 232, which is pivotably disposed in the rotor accommodating hole 231A, a magnetic core (not shown) joined with the stator 231, and a coil 233, which is wound around the magnetic core, as shown in FIG. 3. The rotor 232 is so magnetized as to form two poles (S and N poles), and the stator 231 is made of a magnetic material. A pair of inner notches 231B are so provided on the inner circumference of the rotor accommodating hole 231A of the stator 231 as to face each other in the radial direction of the hole. The rotor 232 receives force that maintains the attitude of the rotor 232 in such a way that a line segment along the direction in which the two magnetic poles, the N pole and the S pole, of the rotor 232 face each other is perpendicular to a line segment passing through the pair of inner notches 231B. The rotor 232 is therefore stationary with the above attitude maintained in a case where no current flows through the coil 233.

When a motor drive pulse is supplied to the opposite terminals of the coil 233 and current therefore flows through the coil 233, a magnetic flux is produced in the stator 231. As a result, interaction between the magnetic poles created in the stator 231 and the magnetic poles of the rotor 232 causes the rotor 232 to pivot by 180° (one step) in the forward or reverse direction. The rotor 232 thus pivots by the unit of 180° whenever the motor drive pulse is supplied to the coil 233. That is, the rotor 232 alternately has one of two different orientations shifted by 180° from each other.

The motor 22 for the hour/minute hands has the same configuration as that of the motor 23 for the center hand shown in FIG. 3.

The motor 23 for the center hand is disposed in an 11-o'clock position with respect to the center of the dial 2 in the plan view, as shown in FIG. 1. The motor 22 for the hour/minute hands is disposed in a 2-o'clock position with respect to the center in the plan view. The rotor 232 of the motor 23 for the center hand is located closer to the magnetism sensor 21 than the rotor of the motor 22 for the hour/minute hands when viewed from the side facing the front side of the timepiece.

The wheel train 25 for the center hand is formed of a plurality of gears and moves the center hand 13 in synchronization with the rotor 232 of the motor 23 for the center hand.

The reduction ratio of the wheel train 25 for the center hand is so set that the center hand 13 moves over the distance corresponding to one marking segment when the rotor 232 makes one turn, that is, when the rotor 232 pivots two steps. The configuration described above allows the rotor 232 to always have the same orientation when the center hand 13 points at any of the markings 2A. That is, in the timepiece, the direction from the S pole toward the N pole (or direction from N pole toward S pole) is always fixed.

The wheel train 24 for the hour/minute hands is formed of a plurality of gears and moves the hour hand 11 and the minute hand 12 in synchronization with the rotor of the motor 22 for the hour/minute hands.

The reduction ratio of the wheel train 24 for the hour/minute hands is so set that the minute hand 12 moves over the distance corresponding to one marking segment when the rotor makes one turn, that is, when the rotor pivots two steps. The configuration described above allows the rotor to always have the same orientation when the minute hand 12 points at any of the markings 2A.

### Configuration of Control Circuit

The control circuit 30 includes a CPU (central processing unit) 31 (processor), an RTC (real-time clock) 32, a driver 33 for the hour/minute hands, a driver 34 for center hand, an LCD driver 35, a crown operation detector 36, a button operation detector 37, a RAM (random access memory) 38, and a ROM (read only memory) 39.

The driver 33 for the hour/minute hands uses a clock signal outputted from the RTC 32 to output motor drive pulses to the motor 22 for the hour/minute hands.

The driver 34 for center hand uses the clock signal to output motor drive pulses to the motor 23 for the center hand.

The LCD driver 35 outputs a drive signal to the LCD 14.

The crown operation detector 36 detects operation performed on the crown 4 and outputs an operation signal according to the operation to the CPU 31.

The button operation detector 37 detects operation performed on the button 5 and outputs an operation signal according to the operation to the CPU 31.

The ROM 39 stores, for example, a program executed by the CPU 31.

The RAM 38 stores, for example, data required when the CPU 31 carries out processes. For example, the RAM 38 stores an offset magnetic field representing the magnetic field produced in the timepiece as a correction value for correcting the magnetism information.

The CPU 31 executes the program stored in the ROM 39 to function as a mode setter 311, an azimuth measurer 312, a calibrator 313, and a display controller 314.

The mode setter 311 sets, in accordance with operation performed on the crown 4 and the button 5, an azimuth mode in which the azimuth is measured and displayed and a calibration mode in which the offset magnetic field described above is acquired.

The azimuth measurer 312 controls the magnetism sensor 21, when the azimuth mode is set, to measure the magnetism in accordance with the operation performed on the button 5 and calculates and acquires the azimuth based on the measured magnetism information.

The calibrator 313 controls the magnetism sensor 21, when the calibration mode is set, to measure the magnetism and calculates and acquires the offset magnetic field.

The display controller 314 controls the driver 33 for the hour/minute hands, the driver 34 for center hand, and the LCD driver 35 to control display operation performed by the hour hand 11, the minute hand 12, the center hand 13, and the LCD 14.

The above functional portions will each be described in detail in the following description of an azimuth measurement action and a calibration action.

### Azimuth Measurement Action

For example, when the button 5 is pressed, the mode setter 311 sets the azimuth mode. At this point, the display controller 314 controls the LCD driver 35 to cause the LCD 14 to display English letters “COMP,” which means a compass, as shown, for example, in FIG. 1, to show that the azimuth mode has been set. It is noted that the hour hand 11 and the minute hand 12 keep displaying the hour and minute, and the center hand 13 points at the 12-o'clock position.

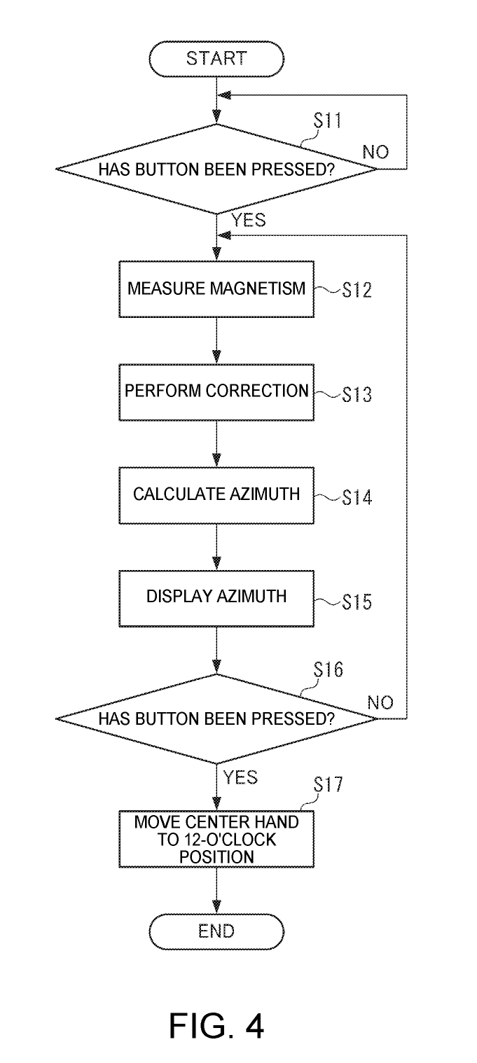

When the azimuth mode is set, the electronic timepiece 1 performs the azimuth measurement action shown in the flowchart of FIG. 4.

The azimuth measurer 312 first evaluates whether or not the button 5 has been pressed (step S11), as shown in FIG. 4. The azimuth measurer 312 repeats the process in step S11 until the button 5 is pressed.

In the case where the button 5 has been pressed and the result of the evaluation in step S11 therefore is YES, the azimuth measurer 312 activates the magnetism sensor 21 to measure the magnetism (step S12). During the magnetism measurement performed by the azimuth measurer 312, the center hand 13 and the minute hand 12 each point at any of the markings 2A.

The azimuth measurer 312 then reads the offset magnetic field from the RAM 38 and corrects the measured magnetism information based on the offset magnetic field (step S13). Specifically, the azimuth measurer 312 removes an offset magnetic field component from the magnetism information and leaves only a geomagnetic component. The azimuth measurer 312 then calculates and acquires the north cardinal point based on the corrected magnetism information (step S14).

The display controller 314 then controls the driver 34 for center hand to cause the center hand 13 to point at the marking 2A corresponding to the acquired north cardinal point to display the north cardinal point (step S15).

The mode setter 311 then evaluates whether or not the button 5 has been pressed again (step S16). In a case where the result of the evaluation in step S16 is NO, the mode setter 311 proceeds to the process in step S12. The processes in steps S12 to S15 are therefore repeatedly carried out until the button 5 is pressed and the result of the evaluation in step S16 therefore becomes YES. In the process in step S12, the magnetism is measured, for example, every 0.5 seconds or 1 second.

When the button 5 is pressed and the result of the evaluation in step S16 is therefore YES, the display controller 314 causes the center hand 13 to point at the 12-o'clock position (step S17) and causes the LCD 14 to stop displaying “COMP.” The mode setter 311 then deactivates the azimuth mode. The azimuth measurement action is thus terminated.

A timeout action (not shown) may be so added that the azimuth mode is deactivated, for example, one or two minutes after the azimuth mode is set. The timeout action allows automatic deactivation of the azimuth mode even if a user forgets to deactivate the azimuth mode, whereby useless power consumption can be avoided.

### Calibration

For example, when the button 5 is pressed with the crown 4 pulled one step, the mode setter 311 sets the calibration mode. At this point, the display controller 314 causes the LCD 14 to display English letters “CAL” to show that the calibration mode has been set.

When the calibration mode is set, the electronic timepiece 1 performs the calibration action.

The calibrator 313 first activates the magnetism sensor 21 to measure the magnetism. The display controller 314 then causes the LCD 14 to display a message that prompts the user to rotate the attitude of the electronic timepiece 1 by 180°. After the user rotates the electronic timepiece 1 by 180°, when the user presses the button 5 again, the calibrator 313 activates the magnetism sensor 21 again and measure the magnetism. During the magnetism measurement performed by the calibrator 313, the center hand 13 and the minute hand 12 each point at any of the markings 2A.

The calibrator 313 then calculates and acquires the average of the first measured value and the second measured value. Rotating the attitude of the electronic timepiece 1 by 180° in accordance with the message described above before the second measurement is performed and acquiring the average allow acquisition of magnetism information from which the geomagnetic component is removed, that is, the offset magnetic field. The calibrator 313 then stores the acquired value as the offset magnetic field in the RAM 38.

Thereafter, when the crown 4 is pressed back to the zero-step position, the display controller 314 causes the LCD 14 to stop displaying “CAL”, and the mode setter 311 deactivates the calibration mode. The calibration action is thus terminated.

### Advantageous Effect of First Embodiment

According to the present embodiment, when the magnetism is measured in the azimuth mode, the rotor of each of the motor 23 for the center hand and the motor 22 for the hour/minute hands is always oriented in the fixed direction. The magnetism can therefore be measured with the magnetic field produced in the timepiece maintained in the same state whenever the measurement is performed, whereby the azimuth can be measured with accuracy. Further, since the rotors are not required to pivot before the magnetism measurement, the period necessary for the azimuth measurement can be shortened.

According to the present embodiment, when the magnetism is measured in the calibration mode, the rotor of each of the motor 23 for the center hand and the motor 22 for the hour/minute hands is allowed to have the same orientation with which the azimuth measurement is performed. The magnetic field produced in the timepiece can therefore be maintained in the same state as that in the azimuth measurement, whereby an appropriate offset magnetic field can be acquired. The azimuth can therefore be measured with accuracy.

### Second Embodiment

In the first embodiment, in which the center hand 13 moves over the distance corresponding to one marking segment when the rotor 232 makes one turn (pivots two steps), electric power required to move the center hand 13 over the distance corresponding to one marking segment is greater, for example, than in a case where the center hand 13 moves over the distance corresponding to one marking segment when the rotor 232 makes a half turn (pivots one step). Therefore, for example, in a case where the center hand 13 is configured to function also as the second hand in a normal mode, the frequency at which the center hand 13 is driven increases, and the electric power consumed by the timepiece increases accordingly.

In contrast, an electronic timepiece 1A according to a second embodiment includes a small second hand 15 and a motor 26 for the small second hand, which drives the small second hand 15, in place of the LCD 14, and the small second hand 15 moves over the distance corresponding to one marking segment when the rotor of the motor 26 for small second hand makes a half turn (pivots one step). The configuration described above allows reduction in the electric power consumed by the timepiece as compared with the case where the center hand 13 is configured to display the second.

The electronic timepiece 1A according to the second embodiment will be described below with reference to the drawings. The same components as those of the electronic timepiece 1 according to the first embodiment have the same reference characters and will not be described.

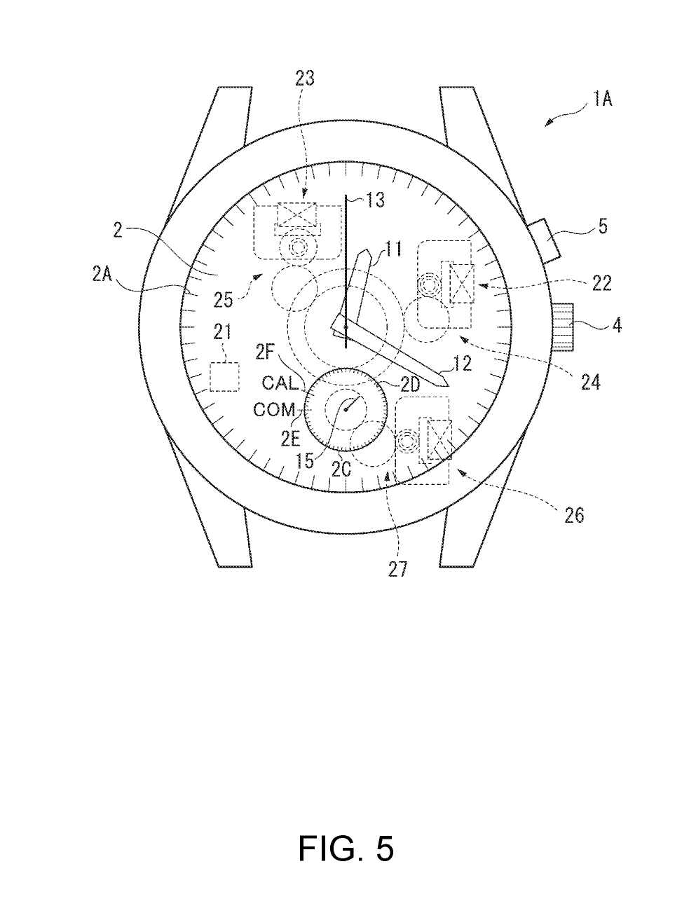

FIG. 5 is a front view showing the electronic timepiece 1A.

The dial 2 of the electronic timepiece 1A is provided with a small window 2C located in a 6-o'clock position with respect to the center of the dial 2 in a plan view and having a circular shape when viewed from the side facing the front side of the timepiece, as shown in FIG. 5. Markings 2D (second markings) are so provided around the outer circumference of the small window 2C as to divide the circumference thereof into 60 segments. A marking 2E (azimuth mode marking), which indicates the azimuth mode, and a marking 2F (calibration mode marking), which indicates the calibration mode, are further provided on the outer circumference of the small window 2C. Further, English letters “COM,” which means a compass, are written in a region outside the marking 2E, and English letters “CAL,” which means the calibration, are written in a region outside the marking 2F.

A rotating shaft is provided at the center of the small window 2C in the plan view, and the small second hand 15 is attached to the rotating shaft. The small second hand 15 functions as the second hand in the normal mode and points at any of the markings 2D to display the second of the time. In the case where the azimuth mode or the calibration mode is set, the small second hand 15 functions as a mode hand; the small second hand 15 points at the marking 2E when the azimuth mode is set and points at the marking 2F when the calibration mode is set.

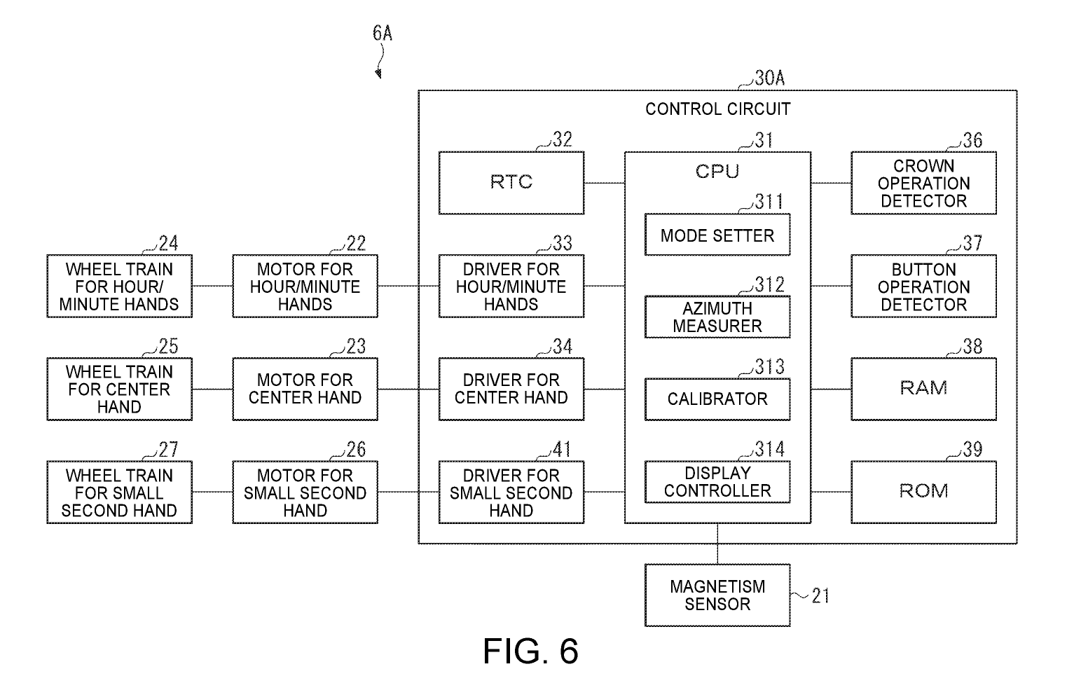

FIG. 6 is a block diagram showing the configuration of a movement 6A of the electronic timepiece 1A.

The movement 6A includes a driver 41 for the small second hand, a motor 26 for the small second hand, and a wheel train 27 for the small second hand in place of the LCD driver 35 and the LCD 14.

The motor 26 for the small second hand is formed of a stepper motor and has the same configuration as that of the motor 23 for the center hand shown in FIG. 3. The motor 26 for the small secondhand is also referred to as a stepper motor for the second hand or a stepper motor for the mode hand.

The motor 26 for the small second hand is disposed in a 5-o'clock position with respect to the center of the dial 2 in the plan view, as shown in FIG. 5. The rotor of the motor 26 for the small second hand (also referred to as rotor for second hand or rotor for mode hand) is located in a position more remote from the magnetism sensor 21 than the rotor 232 of the motor 23 for the center hand when viewed from the side facing the front side of the timepiece.

The wheel train 27 for the small second hand is formed of a plurality of gears and moves the small second hand 15 in synchronization with the rotor of the motor 26 for the small second hand.

The reduction ratio of the wheel train 27 for the small second hand is so set that the small second hand 15 moves over the distance corresponding to one of the segments of the markings 2D when the rotor of the motor 26 for the small second hand makes a half turn, that is, when the rotor pivots one step. Therefore, when the small second hand 15 points at any of the markings 2D, the rotor described above does not always have the same orientation but has either of the two orientations described above.

The driver 41 for the small second hand, which is provided in a control circuit 30A, is controlled by the display controller 314 and uses the clock signal outputted from the RTC 32 to output motor drive pulses to the motor 26 for the small second hand.

In the present embodiment, since the small second hand 15 points at the marking 2E when the azimuth mode is set, the rotor of the motor 26 for the small second hand always has the same orientation (predetermined orientation) in the magnetism measurement.

Further, in the present embodiment, the markings 2E and 2F are so provided as to overlap with the markings 2D with three markings 2D between the markings 2E and 2F. That is, when the rotor of the motor 26 for the small second hand makes two turns (pivots four steps), the small second hand 15 moves between the marking 2E and the marking 2F. According to the configuration described above, the rotor of the motor 26 for the small second hand has the same orientation both in the case where the small second hand 15 points at the marking 2E and the case where the small second hand 15 points at the marking 2F.

The arrangement of the markings 2E and 2F is not limited to the arrangement described above and only needs to be an arrangement in which the small second hand 15 moves between the marking 2E and the marking 2F when the rotor described above makes n turns, where n is an integer greater than or equal to 1. Also in this case, the rotor described above has the same orientation both in the case where the small second hand 15 points at the marking 2E and the case where the small second hand 15 points at the marking 2F.

The electronic timepiece LA, when it starts the azimuth measurement action, carries out the processes in steps S11 to S16, as in the first embodiment. When the result of the evaluation in step S16 shows that the button 5 has been pressed, the display controller 314 causes the small second hand 15 to display the second of the time, and the mode setter 311 deactivates the azimuth mode.

The calibration action in the present embodiment is the same as that in the first embodiment.

### Advantageous Effect of Second Embodiment

According to the present embodiment, when the magnetism is measured in the azimuth mode, the rotor of each of the motor 23 for the center hand, the motor 22 for the hour/minute hands, and the motor 26 for the small second hand is always oriented in the fixed direction. The magnetism can therefore be measured with the magnetic field produced in the timepiece maintained in the same state whenever the measurement is performed, whereby the azimuth can be measured with accuracy. Further, since the rotors are not required to pivot before the magnetism measurement, the period necessary for the azimuth measurement can be shortened.

According to the present embodiment, when the magnetism is measured in the calibration mode, the rotor of each of the motor 23 for the center hand, the motor 22 for the hour/minute hands, and the motor 26 for the small second hand is allowed to have the same orientation with which the azimuth measurement is performed. The magnetic field produced in the timepiece can therefore be maintained in the same state as that in the azimuth measurement, whereby an appropriate offset magnetic field can be acquired. The azimuth can therefore be measured with accuracy.

### OTHER EMBODIMENTS

The invention is not limited to the embodiments described above, and changes, improvements, and other modifications to the extent that the advantage of the invention is achieved fall within the scope of the invention.

### Variation 1

In the second embodiment described above, in the case where the azimuth mode is set, the small second hand 15 stationarily points at the marking 2E, but not necessarily. For example, the small second hand 15 may keep displaying the second.

In this case, however, when the magnetism is measured in the azimuth mode, the rotor of the motor 26 for the small second hand does not always have the same orientation. Therefore, to measure the magnetism, the orientation of the rotor is detected, and the measured magnetism information is corrected in accordance with the detected orientation of the rotor for azimuth acquisition.

That is, in Variation 1, a CPU 31B includes not only the mode setter 311, the azimuth measurer 312, the calibrator 313, and the display controller 314 but an orientation detector 315, which detects the orientation of the rotor of the motor 26 for the small second hand. The orientation detector 315 detects the orientation of the rotor described above, for example, by evaluating whether the second at which the small second hand 15 points is an odd second or an even second.

Further, in the case where the calibration mode is set, the electronic timepiece carries out not only the process of acquiring the offset magnetic field but the process of acquiring an orientation correction value for correcting the magnetism information in accordance with the orientation of the rotor of the motor 26 for the small second hand.

Specifically, the calibrator 313 activates the magnetism sensor 21 with the rotor described above having one of the two orientations described above to measure the magnetism. The display controller 314 then controls the driver 41 for the small secondhand to cause the rotor described above to pivot by 180° (one step). The calibrator 313 then measures the magnetism again.

The calibrator 313 then calculates the difference between the first measured value and the second measured value and stores the difference as the orientation correction value in the RAM 38.

In the azimuth measurement action, when the magnetism information is corrected in step S13, the orientation detector 315 detects the orientation of the rotor of the motor 26 for the small second hand. The azimuth measurer 312 then evaluates whether or not the orientation of the rotor coincides with the orientation of the rotor at the time of acquisition of the offset magnetic field, and when they coincide with each other, the magnetism information is corrected based on the offset magnetic field. On the other hand, when they do not coincide with each other, the magnetism information is corrected based on the offset magnetic field and the orientation correction value.

A decrease in the accuracy in the azimuth measurement can thus be suppressed.

When the magnetism information is corrected in accordance with the orientation of the rotor, the accuracy in the azimuth measurement lowers in some cases due to a correction error. In Variation 1, however, since the rotor of the motor 22 for the hour/minute hands and the rotor 232 of the motor 23 for the center hand always have the same orientation, no correction according to the orientations of the rotors is performed. Therefore, the effect of the correction error can be reduced as compared with a case where correction is performed in consideration of the orientations of all rotors, whereby a decrease in the accuracy of the azimuth can be suppressed.

### Variation 2

In each of the embodiments and the variation, the reduction ratio of the wheel train 25 for the center hand is so set that the center hand 13 moves over the distance corresponding to one marking segment when the rotor 232 makes one turn, but not necessarily. That is, the reduction ratio only needs to be so set that the center hand 13 moves over the distance corresponding to one marking segment when the rotor 232 makes N turns, where N is an integer greater than or equal to 1. According to the configuration described above, when the center hand 13 points at any of the markings 2A, the rotor 232 always has the same orientation.

Similarly, the reduction ratio of the wheel train 24 for the hour/minute hands only needs to be so set that the minute hand 12 moves over the distance corresponding to one marking segment when the rotor of the motor 22 for the hour/minute hands makes N turns.

### Variation 3

In each of the embodiments and the variations, the reduction ratio of the wheel train 24 for the hour/minute hands is so set that the minute hand 12 moves over the distance corresponding to one marking segment when the rotor of the motor 22 for the hour/minute hands makes N turns, but not necessarily.

That is, the rotor of the motor 22 for the hour/minute hands is located in a position more remote from the magnetism sensor 21 than the rotor 232 of the motor 23 for the center hand. The effect of the rotor of the motor 22 for the hour/minute hands on the accuracy in the azimuth measurement is smaller than that of the rotor 232 of the motor 23 for the center hand. Therefore, in a case where the effect of the rotor of the motor 22 for the hour/minute hands on the measurement accuracy is small, the rotor does not always have the same orientation in the magnetism measurement. In this case, for example, the reduction ratio of the wheel train 24 for the hour/minute hands is so set that the minute hand 12 moves over the distance corresponding to one marking segment when the rotor of the motor 22 for the hour/minute hands pivots by 180° (one step), and the consumed electric power can be lowered accordingly. It is noted in this case that the magnetism information may be corrected in accordance with the orientation of the rotor of the motor 22 for the hour/minute hands in the azimuth measurement, as in Variation 1.

### Variation 4

In the first embodiment described above, the center hand 13 points at the 12-o'clock position in the normal mode, but not necessarily. For example, the center hand 13 may point at any of the markings 2A to display the second of the time. That is, the center hand 13 may be allowed to function as the second hand. In this case, the motor 23 for the center hand makes one turn (pivots two steps) every one second, and the center hand 13 moves over the distance corresponding to one marking segment every one second.

What is claimed is:

1. An electronic timepiece comprising:
a mode setter that sets an azimuth mode in which an azimuth is measured and displayed;
at least one indicating hand that operates when the azimuth mode is set;
markings at which the indicating hand points;
a stepper motor including a rotor;
a wheel train that moves the indicating hand in synchronization with the rotor;
a magnetism sensor; and
an azimuth measurer that measures magnetism with the magnetism sensor when the azimuth mode is set and acquires the azimuth based on the measured magnetism information,
wherein a reduction ratio of the wheel train is so set that the indicating hand moves by a distance corresponding to one marking when the rotor makes N turns, where N is an integer greater than or equal to 1, and
the azimuth measurer measures the magnetism during a period for which the indicating hand stationarily points at any of the markings.

2. The electronic timepiece according to claim 1,
wherein the mode setter sets a calibration mode in which a correction value for correcting the magnetism information is acquired,
the electronic timepiece further comprises a calibrator that acquires the correction value when the calibration mode is set by measuring the magnetism with the magnetism sensor during a period for which the indicating hand stationarily points at any of the markings, and
the azimuth measurer corrects the magnetism information based on the correction value to acquire the azimuth.

3. The electronic timepiece according to claim 2, further comprising:
a mode hand provided separately from the indicating hand;
an azimuth mode marking at which the mode hand points when the azimuth mode is set;
a calibration mode marking at which the mode hand points when the calibration mode is set; and
a stepper motor for the mode hand including a rotor for the mode hand,
wherein the mode hand moves between the azimuth mode marking and the calibration mode marking when the rotor for the mode hand makes n turns, where n is an integer greater than or equal to 1.

4. The electronic timepiece according to claim 1, further comprising:
a second hand provided separately from the indicating hand;
second markings at which the second hand points; and
a stepper motor for the secondhand that includes a rotor for the second hand and moves the second hand over a distance corresponding to one marking when the rotor for the secondhand is caused to make a half turn every one second,
wherein the second hand stops with the rotor for the second hand having a predetermined orientation when the azimuth mode is set.

5. The electronic timepiece according to claim 1, further comprising:
a second hand provided separately from the indicating hand;
second markings at which the second hand points;
a stepper motor for the secondhand that includes a rotor for the second hand and moves the second hand over a distance corresponding to one marking when the rotor for the secondhand is caused to make a half turn every one second; and
an orientation detector that detects an orientation of the rotor for the second hand,
wherein the second hand moves every one second when the azimuth mode is set, and
the azimuth measurer corrects the measured magnetism information in accordance with the orientation of the rotor for the second hand to acquire the azimuth.
